(19) United States
(12) Patent Application Publication
(10) Pub. No.: US 2007/0241564 A1
(43) Pub. Date: Oct. 18, 2007

(54) Self powered AC generation system or "SP-A/C-GS"

(76) Inventor: Robert Sutch, Spring, TX (US)

Correspondence Address: ROBERT SUTCH, 7714 POST BRIDGE, SPRING, TX, 77389-3189, US

(21) Appl. No.: 11/401,504

(22) Filed: Apr. 12, 2006

(51) Int. Cl. H02K 7/18; F03G 7/08; F02B 63/04

(52) U.S. Cl. 290/1 R

(57) ABSTRACT

SP-A/C-GS is unique in its self-powering capability, while providing an A/C power supply from a D/C power source.

### CROSS-REFERENCE TO RELATED APPLICATIONS

Not Applicable

### STATEMENT REGARDING FEDERALLY SPONSORED RESEARCH

Not Applicable

### REFERENCE TO SEQUENCE LISTING, COMPUTER LISTING, OR CD

Not Applicable

### BACKGROUND OF INVENTION

Several years of education, research, and just plain old trial & error have gone into this project. The ability to generate alternating or A/C power, thru the use of low voltage direct current or D/C power sources is the basis of this patent application. Current solar panel inverter systems and fossil based fuel generating systems are costly and/or limited fuel reserve capabilities. The scope of my work was to initiate a concept and develop a prototype A/C power generation unit that provides adequate A/C power for general power applications. My work intensified following the several hurricanes and severe weather conditions that have battered the gulf coast in recent years. These storms produced widespread and prolonged commercial power outages, standard gasoline and diesel generators worked well for the short term of these power outages, but due to fuel shortages during the long term outages their usefulness soon diminished The need for a low cost, independent A/C power generating had come, through the use of readily available components and technology, and combining them in such a way, I have developed just such an A/C power generating system. The following pages will outline this A/C power generating system.

### SUMMARY OF INVENTION

The core of this power system is based upon the matching of a 4-stator based A/C miniature power generation head, that can provide power to operate household electrical equipment or illuminating equipment. A 4-stator A/C generator power head coupled with the newer D/C axial gap permanent magnet drive motors are capable of providing the necessary torque and horse power requirements to operate the 4-stator generating power heads. This matched combination provides the core of this prototype power generation system. The addition of a peripheral charging system and a transformer system for long term operation round out this prototype system. The peripheral charging system is made up of solar panels and long duration D/C batteries. The transformer system is made up by a A/C to D/C power transformer. The core system is complimented by the peripheral systems and completes this viable power generation system.

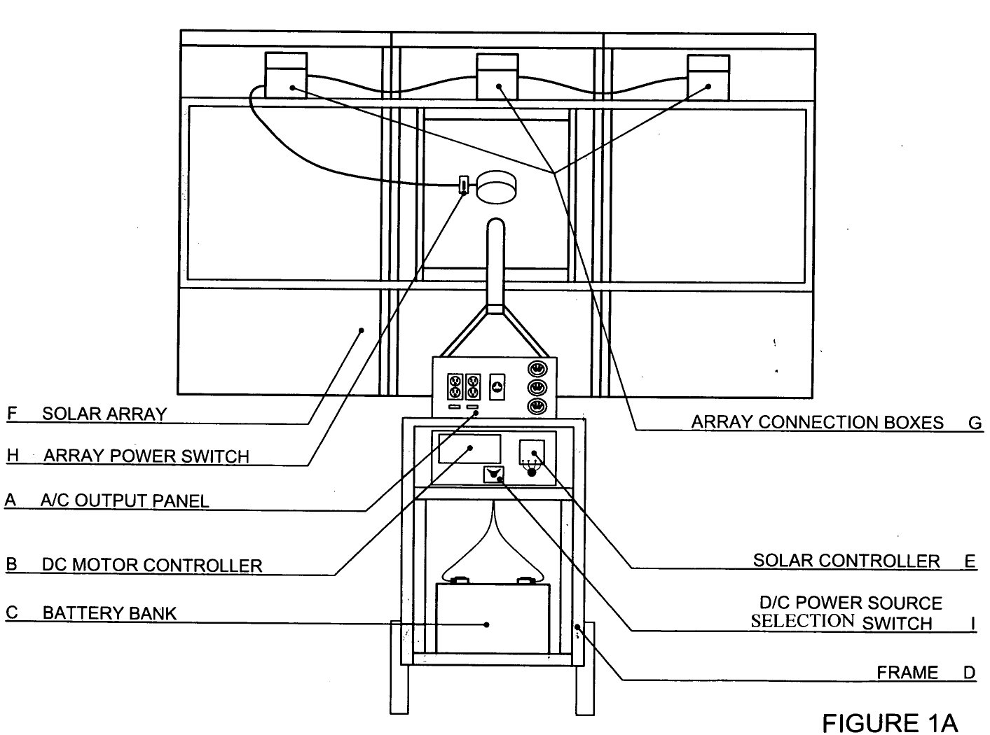

### BRIEF DESCRIPTION OF THE SEVERAL VIEWS OF THE DRAWINGS

[FIG. 1A] Frontal View depicting:

A) AC output panel

B) DC motor controller

C) Battery bank

D) Frame

E) Solar controller

F) Solar array

G) Array connection boxes

H) Array power switch

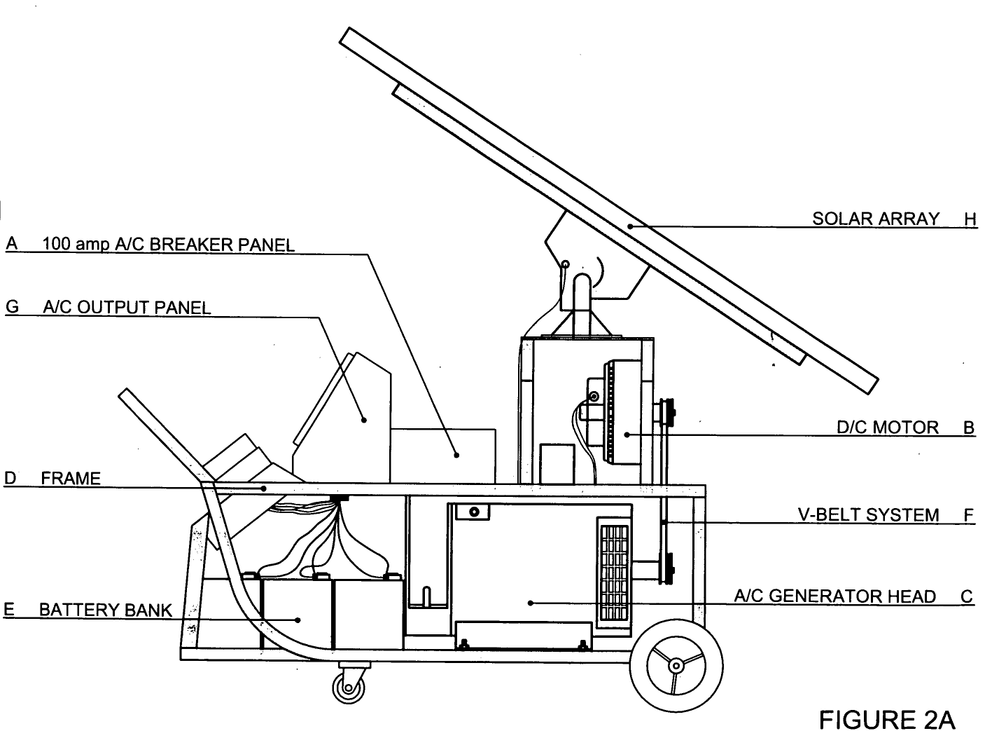

I) D/C power source selection switch

[FIG. 2A] Right Side View depicting:

A) 100 amp A/C breaker panel

B) D/C motor

C) A/C generator head

D) Frame

E) Battery bank

F) V-belt system

G) A/C output panel

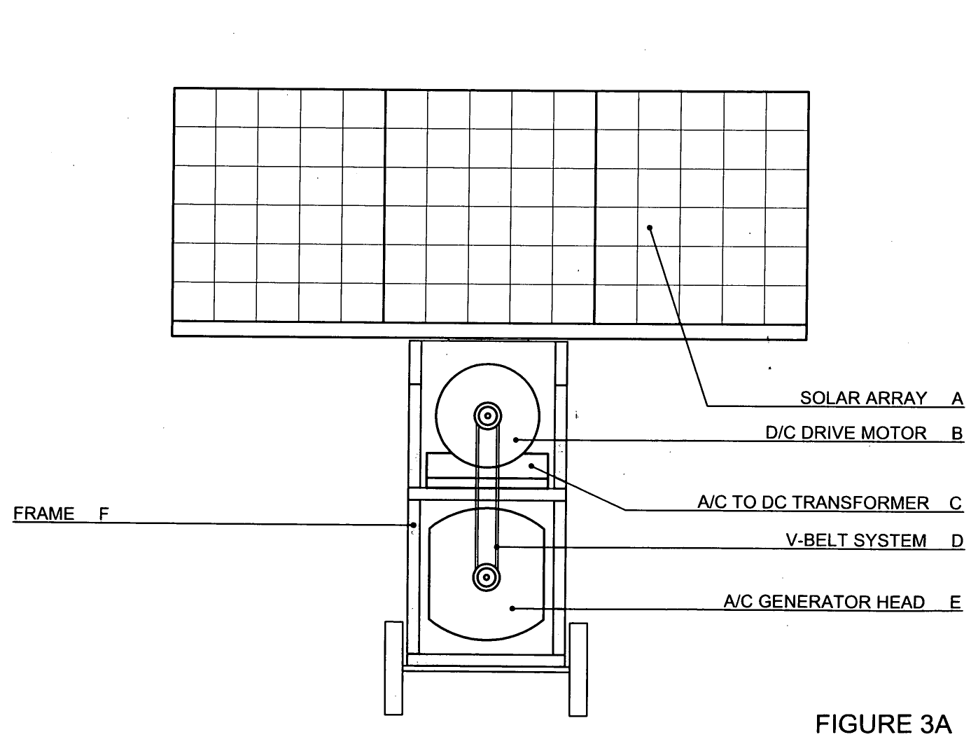

H) Solar array

[FIG. 3A] Rear View depicting:

A) Solar array

B) D/C drive motor

C) A/C to D/C transformer

D) V-belt system

E) A/C generator head

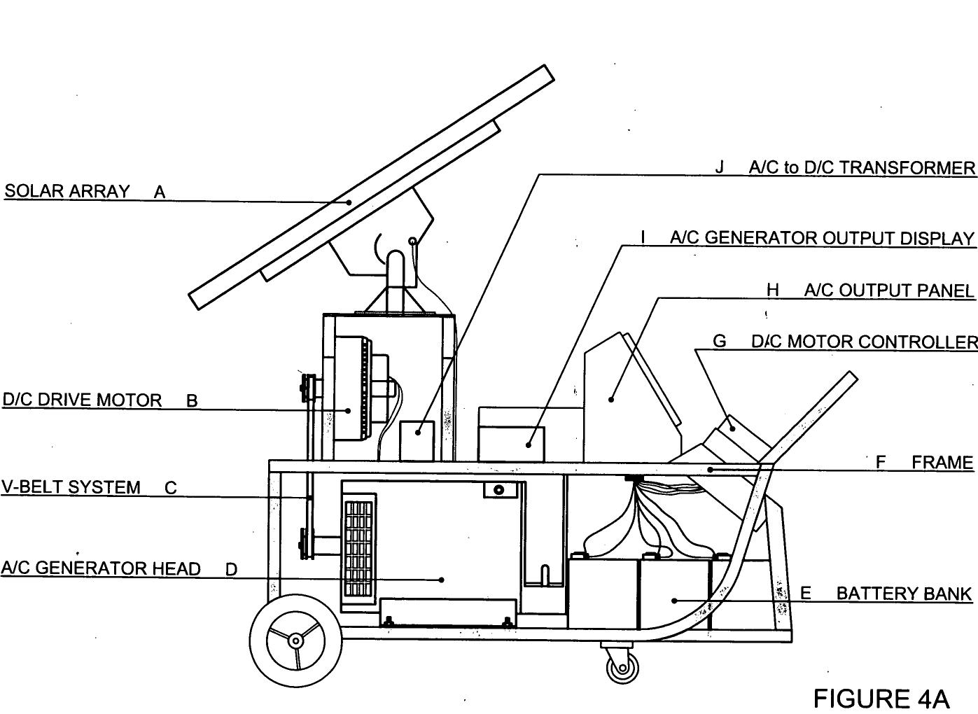

F) Frame

[FIG. 4A] Left Side View depicting:

A) Solar array

B) D/C Drive motor

C) V-belt system

D) A/C generator head

E) Battery bank

F) Frame

G) D/C motor controller

H) A/C output panel

I) A/C generator output display

J) A/C to D/C transformer

### DETAILED DESCRIPTION OF INVENTION

The first core component of SP-A/C-GS is the A/C power generator head. The 4-stator generator head is capable of generating miniature A/C power to operate household electrical equipment and/or illuminating equipment. The 4-stator orientation allows operation at lower RPM requirements and lower horsepower requirements. This 10 kilowatt power head can produce 85 amps output current at the designed output power wattage operating wattage of 10 kilowatts @ 1800 rpms with output frequency of 60 hertz.

The 4-stator generating head is more applicable to this design concept and prototype over the more modem 2-stator, self exciting type generator head, because of the need for the a higher 3600 RPM operating requirement, the higher torque and horsepower requirement, and their lower dependability level.

The older 4-stator type generating head has a proven record of long term dependability, long term operation without malfunction, and in event of malfunction, the low cost of repair.

The second core component of this design concept and prototype is the D/C powered pancake style axial motor, capable of higher horsepower and RPM levels then more conventional D/C motors.

The newer pancake, axial gap permanent magnet, D/C motors are capable of providing higher horse power ratings, higher torque ratings at lower power requirements then conventional D/C motors currently available.

The D/C powered pancake style, axial gap permanent magnet motor that was matched to the above mentioned 4-stator generating head has operating specifications of operation from 12 to 72 volts D/C, 72 RPM per D/C volt, providing 6 to 15 horsepower, with a torque rating 1.14 in lbs/amp providing the necessary horsepower and torque requirements to operate the 10 kilowatt 4-stator power generating head.

The axial gap permanent magnet motor operating at 36 volts DC producing 2592 rpm (no load condition) is mechanically coupled to the generator head using 3 inch v-pulleys in a 1 to 1 ratio utilizing a standard v-groove belt.

The V-belt pulleys and belt is available through any hardware or auto parts store, measurement of belt is dependent upon the final mounting of the D/C pancake axial motor to the 4-stator generating head.

To complete the final core design of this A/C power generating system a medium voltage of 36 volts D/C operation for the pancake axial motor was chosen.

The specification of 72 rpm per D/C volt fell within the rpm requirement of the 10 kilowatt 4-stator generating head to be operated at 1800 rpm producing a 60 hertz A/C power signature which can be optioned at 220 volt A/C with 45 amp, or 110 volt A/C with 90 amp operation, dependent how power head is optioned.

Once the 4-stator power head is optioned (110 A/C 90 amp) and coupled thru the 1 to 1 ratio v-belt pulley system to the D/C axial gap drive motor, the core of the SP-A/C-GS is completed.

Complementing the D/C motor-A/C power head core is the motor controller, one capable of providing the necessary D/C amperage to run the D/C motor at designated rpm specification.

A common pulse width modulated digital 36 volt DC motor controller is used to control the D/C pancake style axial gap drive motor.

The pwm motor controller chosen for this application has operating specifications as follows, 24 and 36 VDC operation, 40-70 amps D/C @ 24 VDC, 25-45 amps D/C @ 36 VDC, a 5 kohm 3-wire pot, and may be held at full current for maximum 30 seconds with a continuous current rating of 25 to 30 amps D/C.

Completing the core component structure is the battery bank, the battery bank will provide the necessary D/C power supply to power the D/C motor controller that in turn regulates the speed of the D/C drive motor.

Three 12 volt D/C gel photovoltaic batteries are used, wired in a simple series D/C connection, they provide the necessary 36 volt D/C power for this system.

A simple roll around steel cart was built to accommodate the core components and provide basic mobility once the steel casters were mounted.

Made out of ¾ inch square steel tubing was cut and welded to provide the structural strength needed to accommodate the weight of the core components and then the addition of the peripheral systems.

The size and shape of the mobile cart will depend upon the size and shape of the components used, and the final design of the end user, whether in a mobile application or in a stationary application.

For this application a mobile frame was preferred for accessability to the various components and any design charges, the addition or subtraction of any component.

A two foot by two foot by four foot carriage was built from ¾ inch mild steel square tubing with ⅛ flat mild steel welded together.

The core components, A/C generator head, The D/C drive motor, the battery bank, and D/C motor controller are mounted to the frame as depicted in the attached drawings.

The A/C generator head was mounted on the bottom tier with the battery bank mounted in front.

The D/C drive motor is mounted on the upper tier, directly above the A/C generator head aligning the shafts directly above each other.

The v-pulleys were mounted on the respective shafts and aligned with each other.

The v belt drive pulleys and v-belt are installed in a direct vertical alignment completing the mechanical coupling of the D/C drive motor and the 4-stator A/C generating head, this is the only mechanical connection in this system, all other connections between components will be on the electrical level.

The battery bank's positive and negative leads are wire to positive and negative 8 terminal buss bars respectively.

The negative input of the D/C motor controller is wired to the negative buss bar.

The negative output of the D/C motor controller is wired to the negative terminal of the D/C drive motor.

The positive input of the D/C motor controller is wired first to output position one of the manual D/C power source switch.

The positive input of the D/C power source switch is wired to the positive bus bar.

The positive output of the D/C motor controller is wired to the positive terminal of the D/C drive motor.

The core system will now run on a fully charged battery bank, motor speed is controlled thru a 5 kohm potentiometer mounter in the D/C motor controller.

The first peripheral sub system is the solar array, three 70 watt, 12 VDC, 8 amp solar panels were mounted to an array frame and wired in a simple D/C series method, providing a total 36 VDC load capacity, with 15 amp D/C full sun charge current.

The solar panels are connected to a 36 VDC solar charge controller that regulates the charging of the battery bank. The solar array acts as a battery charger for the battery bank.

The positive output lead of the solar array is wired to the positive input terminal of the solar charge controller.

The negative output lead of the solar array is wired to the negative input terminal of the solar charge controller.

The positive output from the solar charge controller is wired to the input of a 45 amp 50 VDC zener blocking diode.

The output of the 45 amp 50 VDC zener diode is wired to the positive buss bar.

The negative output lead of the solar charge controller is wired to the negative buss bar.

The solar array charging system is mounted atop the mobile frame, the charge controller is mounted to the front control panel and wired in a simple D/C wiring method, black to negative, red to positive.

all electrical connections were made with simple crimp eyelet terminations.

The zener diode prevents current back feed during night periods when the solar panels are not in use, preventing the battery bank from being discharged and separates the current paths, the charge current path from the D/C motor current path, allowing the current from the solar array to compliment the battery current allowing longer operation periods of this power system.

A master solar array shutoff switch is mounted on the underneath side of the solar array providing a manual way to interrupt the charge path for maintenance work, long storage periods or other reasons turning off of the solar array is necessary.

The next peripheral system is the A/C 100 amp breaker panel and the A/C output panel, the 100 amp A/C breaker panel is attached directly to the A/C Generator head and is wired as positive, neutral and ground per The National Safety Electrical Code. The 100 amp breaker panel is available at a hardware or builders supply.

Two 20 amp breakers are wired to two 110 outlets, two 15 amp breakers are wire to two other 110 outlets and one 30 amp breaker is wired to a single 220 outlet, all outlets are mounted in the A/C output panel for easy access.

The last peripheral subsystem is the A/C to D/C transformer, available from various electrical motor and battery supply houses.

The D/C to A/C transformer used for this application has an input of 110 VAC @ 15 amps producing a 36 VDC @ 35 amps output.

The A/C to D/C transformer is mounted onto the top deck of frame behind the D/C drive motor.

The 110 A/C input (neutral, positive and negative) are wired into the A/C output panel per the National Electrical Safety Code.

The D/C negative output lead is wired to the negative buss bar.

The D/C positive output lead is wired the position 2 input of the D/C source selection switch.

A “word of caution” this system requires the use of two types of electrical voltage and current, both capable of damaging equipment and components, of inflicting serious injury or death from electrocution, if proper safety precautions are not strictly followed.

“WARNING” If you are not a licensed electrician, or certified electronics technician, do not attempt to build this system without proper assistance.

The building process for SP-A/C-GS involved an in-depth knowledge of both A/C and D/C circuitry and a general working knowledge of welding and mechanical assembly.

All electrical makeup of this system is based on The National Electrical Safety Code (NESC) as outlined by the Institute of Electrical & Electronics Engineers (IEEE)

Ampere meters were added to the positive motor lead, positive output lead of battery supply and the positive transformer output lead for measurement and testing purposes.

SP-A/C-GS can operate for 8 to 10 hours on a fully charged battery bank until 50% battery bank depletion duty cycle is reached. The 870 amp hr battery bank will provide 33 amperes of D/C drive motor current for a 22 hr period in calculated theory, but actual operational applications showed optimum operation began curtailing off at the 8-10 hr mark.

The solar array initially charges the battery bank and is used to recharge the battery bank between usages.

Operational usage of solar panel arrays are now common practice in inverter based systems, they provide electrical D/C current and voltage by the excitation of the photovoltaic material they are comprised of.

Their application to powering A/C generators is non existent in commercial power generation.

The positive D/C current input to the D/C motor controller can be set manually to battery bank or transformer, by switching the D/C power source selection switch to position 1 or position 2.

Initially upon startup, in position 1, battery bank power and current is used, rpms are set by D/C motor controller throttle control.

Once 1800 rpms are set or 60 hertz operation is used, the manual D/C power source selection switch can be switched to input 2, the transformer power source.

SP-A/C-GS will now function in the self-powering mode of operation.

The unit will operate in this mode for an indefinite time period, however, one A/C output circuit is used internally and the systems overall A/C output is reduced.

A 10 micro-farade electrolytic 400 VDC motor capacitor is added in parallel to the transformer D/C positive output.

The positive terminal of the motor capacitor is terminated on the terminal is terminated on the negative buss bar.

The capacitor acts as a “battery” in the D/C power selection switching process, it acts as a tank circuit maintaining the 36 volt D/C power input for the momentary switching process.

If the solar array and battery bank are not needed for a particular mode of operation, the transformer A/C input can be plugged into any household 110 VAC outlet and the core system will operate normally.

The attached drawings depicting front, left side, right side, and rear views show only one configuration this system can take, this configuration is a light weight, mobile unit, with great maneuverability. This AC power generation system can be adapted for permanent location usage, or cascaded for higher power requirements.

As A construction site A/C power generation system, or as a backup power generation system, SP-A/C-GS is unique in its self-powering abilities.

1. I claim my design concept and prototype utilizes D/C voltage and current to generate A/C voltage and current.

2. I claim this prototype will use 1260 watts of D/C power to provide generate 10 kilowatts of A/C power.

3. I claim this design concept and prototype exhibits self powering characteristics.

4. (canceled)

5. I claim this design concept and prototype can be used at any time or anywhere to provide miniature A/C power and electricity in various locations and conditions.

6. I claim the AC voltage and current produced by this design concept and prototype can be used to operate miniature A/C based appliances and lighting applications that are 60 hertz frequency based.

7. (canceled)

8. I claim this design concept as described in this patent application has only a simple restriction to power output is the size and power requirements larger components.

9. I claim this design concept and prototype is an efficient and environmentally safe method of producing A/C power

10. (canceled)

11. (canceled)

12. I claim this design concept and prototype can be changed or peripheral subsystems added or subtracted to adapt to other applications.
